(19) United States
(12) Patent Application Publication
(10) Pub. No.: US 2021/0131623 A1
(43) Pub. Date: May 6, 2021

(54) Grooming Assembly

(71) Applicant: Robert Scroggins, Gladstone, MO (US)

(72) Inventor: Robert Scroggins, Gladstone, MO (US)

(21) Appl. No.: 17/086,834

(22) Filed: Nov. 2, 2020

Related U.S. Application Data
(60) Provisional application No. 62/931,272, filed on Nov. 6, 2019.

(51) Int. Cl. F21S 6/00; A01K 13/00; F21S 4/22; F21V 21/32; F21V 9/40; F21V 21/096

(52) U.S. Cl. CPC F21S 6/003; A01K 13/00; F21S 4/22; F21Y 2115/10; F21V 9/40; F21V 21/096; F21V 21/32

(57) ABSTRACT

A lighting component attachable to a grooming table and grooming table assembly incorporating the lighting component. The grooming table assembly comprises a grooming platform and a grooming arm extending from the grooming platform. The grooming table assembly is configured to allow a pet to be placed on the platform and held in place via at least one grooming loop extending from the grooming arm. The lighting component comprises a housing and a lighting component attachable to the housing. The housing is bendable and adjustable. The lighting component is attachable to the grooming arm via a grooming arm attachment portion which may be a magnetic of mechanical attachment.

### CROSS-REFERENCE TO RELATED APPLICATION

The present application claims priority to, and the benefit of, U.S. Provisional Application No. 62/931,272, which was filed on Nov. 6, 2019 and is incorporated herein by reference in its entirety.

### BACKGROUND

The present invention generally relates to a grooming assembly, and more specifically to a grooming table assembly configured to make pet grooming easier and more efficient. Accordingly, the present specification makes specific reference thereto. However, it is to be appreciated that aspects of the present invention are also equally amenable to other like applications, devices and methods of manufacture.

Pet grooming tables are never equipped with ample lighting allowing a groomer to view all areas of a pet with ease. Groomers may miss multiple areas that need to be groomed or be unable to see ticks, fleas, or other pets on the pet. Typically, groomers are forced to use multiple light sources while completing grooming tasks. Unfortunately, bulky floor lights can create tripping hazards around the grooming table due to long cords.

Grooming a pet is a time consuming and difficult process. Pets rarely want to sit still while a groomer tends to their needs. Both the pet and the groomer can be at risk for injury while attempting to complete the grooming process. Tasks such as clipping, washing, drying, and trimming require significant attention and usually both hands of the groomer. Even well-lit spaces do not provide adequate light for the groomer. There is always an awkward area to reach that is not well lit by the normal lighting. Groomers often rely on hand-held lights which detract from their ability to complete tasks as they require at least one hand to operate. This is also less safe as they have one less hand to control or protect the pet while on the table which is typically elevated causing a danger of the pet falling off of the table.

Another solution to providing adequate lighting involves the use of one or more portable lighting apparatuses. While they can be beneficial, they must be constantly repositioned as throughout the grooming process as the pet moves, or as the groomer needs to address different areas of the pet. Additionally, they take up valuable space especially if positioned on the floor around the grooming table. Floor lighting is also a trip and fall hazard as the groomer is concentrating on grooming the pet and not on the surrounding barriers. The groomer can easily bump into the light or trip on a light cord.

In this manner, the improved grooming table assembly of the present invention accomplishes all of the forgoing objectives, thereby providing an easy solution easily and safely grooming a pet or animal. A primary feature of the present invention is a grooming table assembly with enhanced lighting configured to illuminate all areas of the pet. Finally, the enhanced lighting of the present invention is adjustable allowing the groomer well-lit access to all areas of the pet while completing grooming tasks.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a lighting apparatus attachable to a grooming table. The lighting apparatus comprises a housing, a grooming table arm attachment element, and a lighting element. The lighting element is attachable to the housing. The lighting apparatus is attachable to an arm of the grooming table via the grooming table arm attachment element anywhere along a length of the arm. The housing is flexible and configured to retain its shape once bent. The grooming table attachment element may be a magnetic element or a mechanical element. The lighting element comprises a LED light strip that is adhered or otherwise flexibly attachable to the housing. The lighting element may further comprise a directional lamp attachable to the housing. The lighting apparatus may be battery powered. Alternatively, the lighting apparatus may further comprise a plug and a cord.

In an additional embodiment, the subject matter disclosed and claimed herein comprises a grooming table assembly. The grooming table assembly comprises a grooming platform, a grooming arm, and a lighting component. The grooming arm is attachable to and extends from the grooming platform. The lighting component is adjustably attachable to the grooming arm.

The lighting component comprises a housing, a grooming arm attachment element, and a lighting element. The lighting element is attachable to the housing. The lighting component is attachable to the grooming arm via the grooming arm attachment element anywhere along a length of the grooming arm. The housing is flexible and configured to retain its shape once bent. The grooming arm attachment element may be a magnetic element or a mechanical element. The lighting element comprises a LED light strip that is adhered or otherwise flexibly attachable to the housing. The lighting element may further comprise a directional lamp attachable to the housing. The lighting component may be battery powered. Alternatively, the lighting component may further comprise a plug and a cord.

In an additional embodiment, the subject matter disclosed and claimed herein comprises a grooming table assembly. The grooming table assembly comprises a grooming platform, a grooming arm, a first lighting component, and a second lighting component. The grooming arm is attachable to and extends from the grooming platform. The first and second lighting components are each adjustably attachable to the grooming arm or the grooming platform.

The first lighting component comprises a housing, a grooming arm attachment element, and a lighting element. The lighting element is attachable to the housing. The first lighting component is attachable to the grooming arm via the grooming arm attachment element anywhere along a length of the grooming arm. The housing is flexible and configured to retain its shape once bent. The grooming arm attachment element may be a magnetic element or a mechanical element. The lighting element comprises a LED light strip that is adhered or otherwise flexibly attachable to the housing. The lighting element may further comprise a directional lamp attachable to the housing. The first lighting component may be battery powered. Alternatively, the first lighting component may further comprise a plug and a cord.

The second lighting component comprises a housing, a grooming arm attachment element, and a lighting element. The lighting element is attachable to the housing. The second lighting component is attachable to the grooming arm via the grooming arm attachment element anywhere along a length of the grooming arm. The housing is flexible and configured to retain its shape once bent. The grooming arm attachment element may be a magnetic element or a mechanical element. The lighting element comprises a LED light strip that is adhered or otherwise flexibly attachable to the housing. The lighting element may further comprise a directional lamp attachable to the housing. The second lighting component may be battery powered. Alternatively, the second lighting component may further comprise a plug and a cord.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of a grooming table assembly of the present invention in accordance with the disclosed architecture.

FIG. 2 illustrates a perspective view of a lighting component of the grooming table assembly of the present invention in accordance with the disclosed architecture.

FIG. 3 illustrates a perspective view of the lighting component of the grooming table assembly of the present invention in a bent configuration in accordance with the disclosed architecture.

FIG. 4 illustrates a perspective view of the lighting component of the grooming table assembly of the present invention in accordance with the disclosed architecture.

FIG. 5 illustrates a side view of the lighting component extending from a grooming arm of the grooming table assembly of the present invention in accordance with the disclosed architecture.

FIG. 6 illustrates a side view of a first and second lighting components of a grooming table assembly of the present invention attached to a grooming arm of the grooming table assembly in accordance with the disclosed architecture.

FIG. 7 illustrates a perspective view of the first and second lighting components of the grooming table assembly of the present invention attached to the grooming arm and a grooming platform of the grooming table assembly in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention provides pet groomers with a modified grooming table assembly equipped with a LED or similar light strip, and that functions as a useful grooming tool for groomers at dog shows, ensuring pets are properly trimmed and groomed for their scheduled appearances and events. More specifically, the device includes an LED light strip capable of being magnetically or mechanically attached to a grooming arm and offers adjustable illumination to the dog groomer without using and/or tangling cords. Additionally, the device maximizes efficiency when grooming dogs, saving extensive time and effort.

The grooming table light is an improved grooming table for dogs. The assembly is preferably comprised of a grooming table with a grooming table arm, and a lighting system can be magnetically attached to the table arm. The lights can be comprised of an LED light strip attached to a metal piece with an elongated profile. The metal piece is preferably magnetic, and attachable to the table arm. The table arm can then be moved and adjusted to illuminate all areas of a pet during the grooming process. Exact size, measurement, construction, and design specifications may vary upon further development and manufacturing.

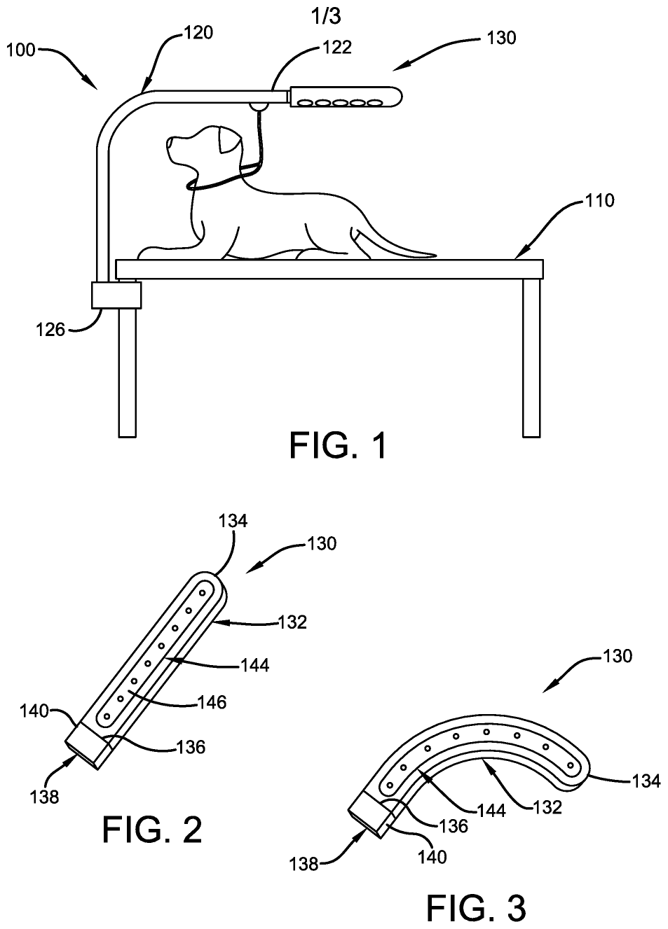

Referring initially to the drawings, FIG. 1 illustrates a lighting apparatus 130 attachable to a grooming table 110. The grooming table 110 is configured to hold a pet or animal form grooming or veterinary services. As illustrated in FIGS. 2-4, the lighting apparatus 130 comprises a housing 132, a grooming table arm attachment element 138, and a lighting element 144. The lighting apparatus 130 is flexibly adjustable. The housing 132 is typically a metal or plastic strip or bar that is flexible and configured to retain its shape once bent as illustrated in FIG. 3. The housing 132 comprises a distal end 134 and a proximal end 136. The lighting apparatus 130 is attachable to a grooming arm 120 of the grooming table 110 via the grooming table arm attachment element 138. The grooming table arm attachment element 138 is attached to the proximal end 136 of the housing 132. The attachment may occur anywhere along a length of the grooming arm 120. The grooming table attachment element 138 may use a magnetic or mechanical connection.

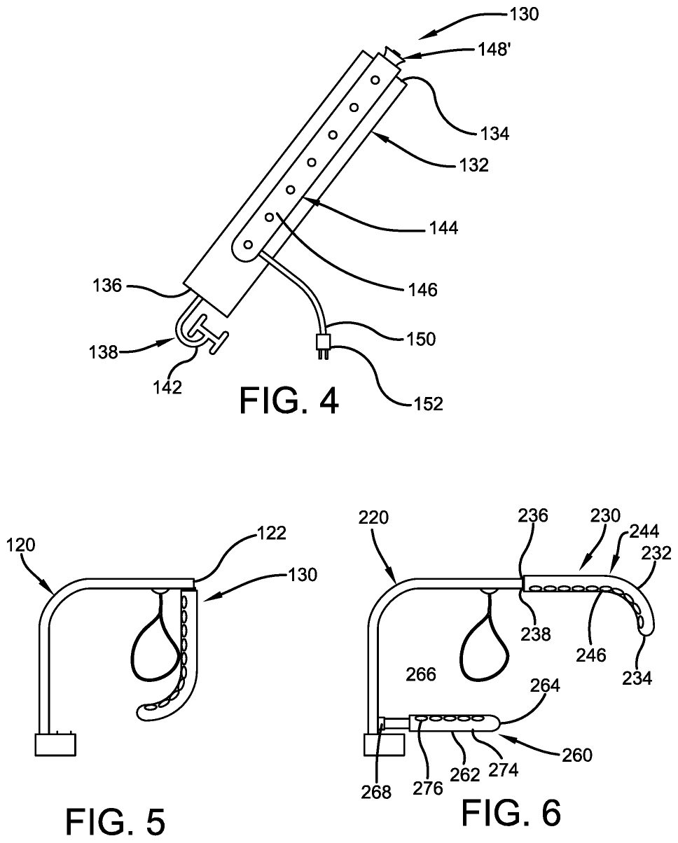

The lighting element 144 is attachable to the housing 132. The lighting element 144 comprises a plurality of LED lamps 146 configured as a LED light strip or similar flexible lighting strip that is adhered or otherwise flexibly attachable to a surface of the housing 132. The lighting element 132 may further comprise a directional lamp 148 attachable to the distal end 134 of the housing 132. The lighting apparatus 130 may be battery powered. Alternatively, as illustrated in FIG. 4, the lighting apparatus 130 may further comprise a plug 150 and a cord 152.

In an additional embodiment as illustrated in FIGS. 1-5, the subject matter disclosed and claimed herein comprises a grooming table assembly 100. The grooming table assembly 100 comprises a grooming platform 110, a grooming arm 120, and a lighting component 130. The grooming arm 120 comprises a distal end 122 and a platform attachment end 126. The grooming arm 120 is attachable to and extends from the grooming platform 110 at the platform attachment end 126. The lighting component 130 is adjustably attachable to the grooming arm 120 at either the distal end 122 or anywhere else along a length of the grooming arm 120.

The lighting component 130 comprises a housing 132, a grooming arm attachment element 138, and a lighting element 144. The housing 132 is typically a metal or plastic strip or bar that is flexible and configured to retain its shape once bent. The housing 132 comprises a distal end 134 and a proximal end 136. The lighting component 130 is attachable to the grooming arm 120 via the grooming arm attachment element 138. The grooming arm attachment element 138 is attached to the proximal end 136 of the housing 132. The attachment of the lighting component 130 may occur at the distal end 122 or anywhere else along the length of the grooming arm 120. The grooming table attachment element 138 may comprise a magnetic attachment element 140 for magnetically engaging the grooming arm 120. The grooming table attachment element 138 may alternatively comprise a mechanical attachment element 142 as illustrated in FIG. 4. The mechanical attachment element 142 may be a bracket, screw mechanism, or any other type of mechanical attachment as is known in the art.

The lighting element 144 is attachable to the housing 132. The lighting element 144 comprises a plurality of LED lamps 146 configured as a LED light strip or similar flexible or bendable lighting strip that is adhered or otherwise flexibly attachable to a surface of the housing 132. The lighting element 144 may be adjustable in intensity. The lighting element 132 may further comprise a directional lamp 148 attachable to the distal end 134 of the housing 132. The lighting apparatus 130 may be battery powered. Alternatively, as illustrated in FIG. 4, the lighting apparatus 130 may further comprise a plug 150 and a cord 152.

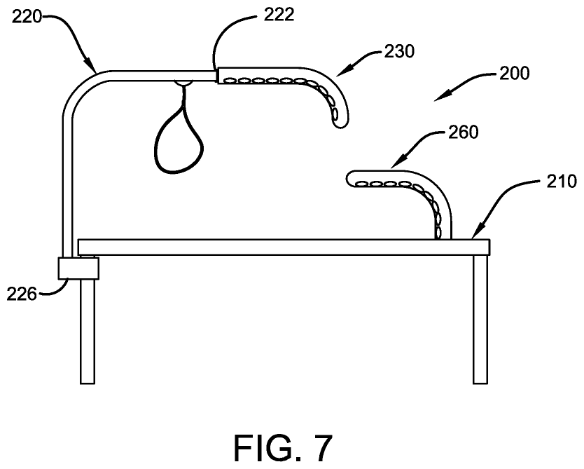

In an additional embodiment as illustrated in FIGS. 6 and 7, the subject matter disclosed and claimed herein comprises a grooming table assembly 200. The grooming table assembly 200 comprises a grooming platform 210, a grooming arm 220, a first lighting component 230, and a second lighting component 260. The grooming arm 220 comprises a distal end 222 and a platform attachment end 226. The grooming arm 220 is attachable to and extends from the grooming platform 210 at the platform attachment end 226. The first and second lighting components 230 and 260 are adjustably attachable to the grooming arm 220 at either the distal end 222, anywhere else along a length of the grooming arm 220, or to the grooming platform 210 at a first position and a second position respectively.

The first lighting component 230 comprises a housing 232, a grooming arm attachment element 238, and a lighting element 244. The housing 232 is typically a metal or plastic strip or bar that is flexible and configured to retain its shape once bent. The housing 232 comprises a distal end 234 and a proximal end 236. The first lighting component 230 is attachable to the grooming arm 220 via the grooming arm attachment element 238. The grooming arm attachment element 238 is attached to the proximal end 236 of the housing 232. The attachment of the first lighting component 230 may occur at the distal end 222 or anywhere else along the length of the grooming arm 220. The grooming table attachment element 238 may use a magnetic or mechanical connection.

The lighting element 244 is attachable to the housing 232. The lighting element 244 comprises a plurality of LED lamps 246 configured as a LED light strip or similar flexible or bendable lighting strip that is adhered or otherwise flexibly attachable to a surface of the housing 232. The lighting element 244 may be adjustable in intensity. The lighting element 232 may further comprise a directional lamp (similar to 148) attachable to the distal end 234 of the housing 232. The lighting apparatus 230 may be battery powered or further comprise a plug (similar to 150) and a cord (similar to 152).

The second lighting component 260 comprises a housing 262, a grooming arm attachment element 268, and a lighting element 274. The housing 262 is typically a metal or plastic strip or bar that is flexible and configured to retain its shape once bent. The housing 262 comprises a distal end 264 and a proximal end 266. The second lighting component 260 is attachable to the grooming arm 220 via the grooming arm attachment element 268. The grooming arm attachment element 268 is attached to the proximal end 266 of the housing 262. The attachment of the second lighting component 260 may occur at the distal end 222, anywhere else along the length of the grooming arm 220, or on the grooming platform 210. The grooming table attachment element 268 may be a magnetic or mechanical connection.

The lighting element 274 is attachable to the housing 262. The lighting element 274 comprises a plurality of LED lamps 276 configured as a LED light strip or similar flexible or bendable lighting strip that is adhered or otherwise flexibly attachable to a surface of the housing 272. The lighting element 274 may be adjustable in intensity. The lighting element 262 may further comprise a directional lamp (similar to 148) attachable to the distal end 264 of the housing 262. The second lighting component 260 may be battery powered or further comprise a plug (similar to 150) and a cord (similar to 152).

It is contemplated that the lighting apparatus 130 and the grooming table assembly 100 and 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lighting apparatus for attaching to a grooming table comprising:
a housing;
a grooming table arm attachment element;
a lighting element attachable to the housing; and
wherein the grooming table arm attachment element is attachable to an arm of the grooming table anywhere along a length of the arm.

2. The lighting apparatus of claim 1, wherein the lighting apparatus is flexibly adjustable.

3. The lighting apparatus of claim 1, wherein the grooming table arm attachment element attaches to the arm magnetically.

4. The lighting apparatus of claim 1, wherein the lighting element comprises a plurality of LED lamps.

5. The lighting apparatus of claim 1, wherein the lighting apparatus is battery powered.

6. The lighting apparatus of claim 1, wherein the lighting apparatus further comprises an electrical cord and a plug.

7. A grooming table assembly comprising:
a grooming platform;
a grooming arm extending from the grooming platform;
a lighting component adjustably attachable to the grooming arm; and
wherein the lighting component compromises a housing, a grooming arm attachment element, and a lighting element attached to the housing.

8. The grooming table assembly of claim 7, wherein the lighting element is a strip of LED lamps.

9. The grooming table assembly of claim 7, wherein the housing and the lighting element are bendable.

10. The grooming table assembly of claim 7, wherein the lighting element comprises at least one directional lamp.

11. The grooming table assembly of claim 7, wherein the lighting element is adjustable in intensity.

12. The grooming table assembly of claim 7, wherein the lighting component is attached to a distal end of the grooming arm.

13. The grooming table assembly of claim 7, wherein the grooming arm attachment element comprises a magnetic attachment element.

14. The grooming table assembly of claim 7, wherein the grooming arm attachment element comprises a mechanical attachment element.

15. A grooming table assembly comprising:
a grooming platform;
a grooming arm extending from the grooming platform;
a first lighting component adjustably attachable to the grooming arm at a first position;
a second lighting component adjustable attached to the grooming arm at a second position; and
wherein each lighting component compromises a housing, a grooming arm attachment element, and a lighting element attached to the housing.

16. The grooming table assembly of claim 15, wherein each lighting element comprises a plurality of LED lamps.

17. The grooming table assembly of claim 15, wherein each lighting element is a flexible LED lighting strip.

18. The grooming table assembly of claim 15, wherein either the first or second lighting component is further attachable to the grooming platform.

19. The grooming table assembly of claim 15, wherein both grooming arm attachment elements attach to the grooming arm magnetically.

20. The grooming table assembly of claim 15, wherein the housing of each lighting component retains its shape when bent.
